(19) United States
(12) Patent Application Publication
(10) Pub. No.: US 2009/0099918 A1
(43) Pub. Date: Apr. 16, 2009

(54) Funds accumulation systems and methods

(76) Inventors: Steven T. Ladoulis, Brookline, MA (US); C.Thomas Musson, Yorba Linda, CA (US)

Correspondence Address: ALIX YALE & RISTAS LLP, 750 MAIN STREET, SUITE 1400, HARTFORD, CT, 06103, US

(21) Appl. No.: 11/973,839

(22) Filed: Oct. 10, 2007

(51) Int. Cl. G06Q 40/00

(52) U.S. Cl. 705/14

(57) ABSTRACT

The disclosed systems and methods leverage the buying power of persons affiliated with the Participating Organization (hereafter “Affiliated Individuals”) by negotiating discounts with a network of Preferred Providers of good and services. Funds are generated in the form of discounts when Affiliated Individuals use a particular spending vehicle to make purchases from a Preferred Provider. According to one embodiment, the discounts are not returned to purchasers at the point of sale but are instead transmitted to a System Administrator where they are pooled for the benefit of the Participating Organization.

### FIELD OF THE DISCLOSURE

The present disclosure relates to electronic stored value accounts and spending vehicles such as debit cards and more specifically to group affiliated stored value accounts and debit cards.

### BACKGROUND

Electronic payments have become the standard means for conducting consumer transactions. Instead of using cash, consumers are using a variety of spending vehicles, including credit cards, debit cards, prepaid “stored value” cards and RFID “swipe and go” devices to purchase a wide variety of products and services.

Credit cards have been used for consumer transactions for many years and the infrastructure for processing credit card transactions is well established. The networks that process credit card transactions have been expanded and updated with computerized point of sale (POS) terminals compatible with credit, debit and check cards and electronic networks for the transfer of funds. The use of debit cards and check cards on these networks has expanded dramatically, with the result that a growing number of consumer transactions are carried out using such spending vehicles and funds transferred on electronic networks, rather than cash. The total amount of money flowing through electronic networks from credit and debit transactions is huge. For example, in 2002 the Automated Clearing House (ACH) network processed an estimated eight billion transactions with a total value of approximately $21 trillion.

Many charitable, educational and service organizations seek to accumulate funds through fund raising activities. Most fund raising activities are characterized by significant up-front costs to the organization, low net returns and diversion of human resources of the organization away from the organization's core mission. Further, there may be laudable objectives of an organization that fall outside the organization's core mission. Examples include providing pension or health care benefits to employees. Well-managed service organizations and non-profits seek to maximize the application of available funds to meeting the service goals of the organization, meaning that salaries and benefits of employees are typically lower than comparably skilled persons working in for-profit companies or government. Another contributing factor is the employees' dedication to service, making them more likely to work for less than they otherwise might. These circumstances can make it difficult for employees of non-profits and service providers to maintain benefits such as health insurance or to accumulate funds for retirement.

### SUMMARY

The disclosed funding systems and methods take advantage of the efficiencies and volume of electronic commerce and the combined purchasing power of many individuals to accumulate funds for the benefit of a Participating Organization. The disclosed systems and methods leverage the buying power of persons affiliated with the Participating Organization (hereafter “Affiliated Individuals”) by negotiating discounts with a network of Preferred Providers of good and services. Funds are generated in the form of discounts when Affiliated Individuals use a particular spending vehicle to make purchases from a Preferred Provider. According to one embodiment, the discounts are not returned to purchasers at the point of sale but are instead transmitted to a System Administrator where they are pooled for the benefit of the Participating Organization.

An embodiment of a funds accumulation system operates on existing banking and point of sale networks according to agreements negotiated among participating entities. Participating entities will typically include a System Administrator, a Host Financial Organization, Preferred Providers of goods and services, Participating Organizations (whose employees or members are the Affiliated Individuals) and providers of funds transfer network services such as ACH. The System Administrator, through a Host Financial Institution 30, provides each of the Affiliated Individuals with a debit account associated with a spending vehicle such as a debit card. The debit account may be funded by the Affiliated Individual on an “as needed” basis or through regular deposits such as by payroll deduction. The Host Financial Institution 30, such as a bank, administers the debit account and issues a debit card (or other spending vehicle) to each Affiliated Individual, which can be used anywhere debit cards are accepted. The debit card may be a private label debit card showing the name and emblem of the Participating Organization on its face. The debit card may include a listing of Preferred Providers on the back side. The Participating Organization promotes use of the debit cards to Affiliated Individuals such as employees or members. Affiliated Individuals are motivated to use the spending vehicles because the disclosed systems and methods allow them to generate funds for the Participating Organization with an activity that essentially costs them nothing; the funds being spent at preferred providers are presumably funds the Affiliated Individuals would be spending in any case. The disclosed funds accumulation systems and methods make participation convenient and require minimal resources from Participating Organizations, Affiliated Individuals or Preferred Providers.

The disclosed methods may be embodied in a computer-readable storage medium having a computer-readable program stored therein for directing operation of a host system. A host system may include an input device, a communications system, a processor, and a storage device. The computer-readable program includes instructions for operating the host system to process financial transactions according to the disclosed embodiments.

The disclosed systems may be embodied in several computers linked by a network and connected to peripheral devices for conducting consumer transactions, accessing funds located in accounts, and storing information regarding consumer transactions, account activity and balances.

### BRIEF DESCRIPTION OF THE DRAWINGS

FIG. 1 is a block diagram of a representative funding system, showing funds flow and functional relationships between components of the system;

FIG. 2 illustrates an exemplary computer system that may be used to implement the disclosed systems and methods; and

FIG. 3 illustrates an exemplary point of sale system compatible with the disclosed systems and methods.

### DETAILED DESCRIPTION

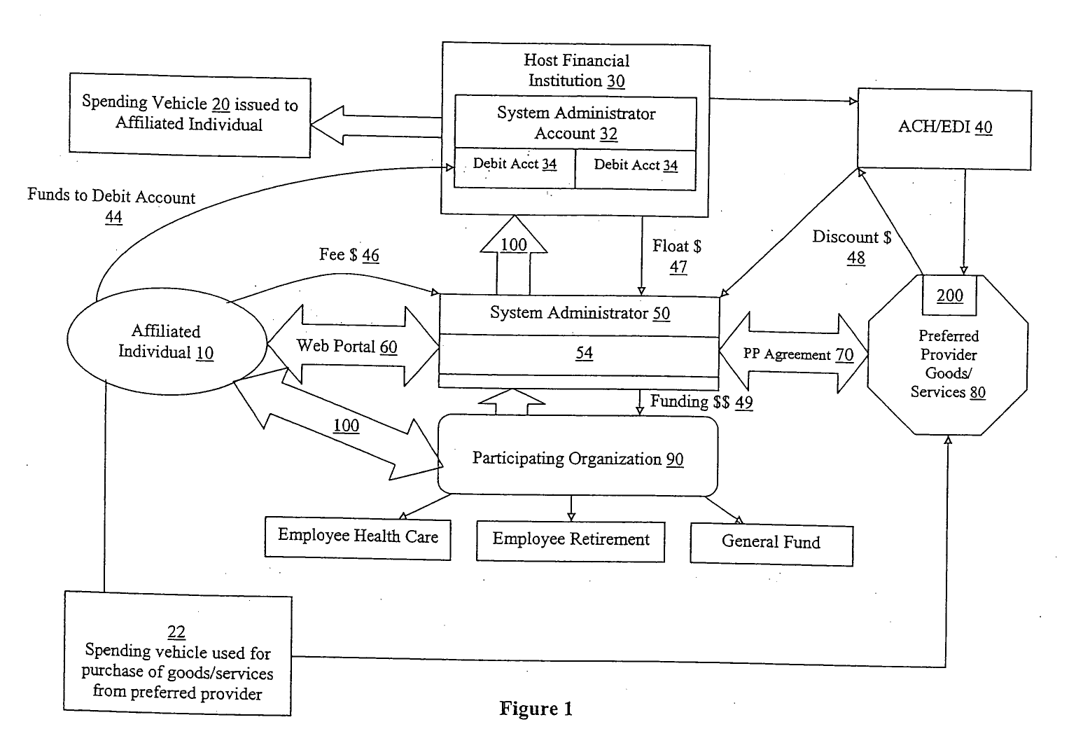

An embodiment of a funds accumulation system according to the disclosure is a cooperative arrangement among participating entities facilitated by a System Administrator 50 as shown in FIGS. 1-3. The rights and obligations of the participating entities are defined in agreements negotiated with the System Administrator 50. Embodiments of the disclosed funds accumulation system will typically operate on electronic networks 40 according to programmed instructions contained in one or more computers. Electronic networks 40 provide for communications and funds transfers among the participating entities as well as point of sale terminals for conducting consumer transactions.

The System Administrator 50 manages the relationships among participating entities and promotes use of the disclosed funds accumulation systems and methods to prospective Participating Organizations 90. Management of the disclosed systems and methods by the System Administrator 50 relieves the Participating Organization and its staff from the burden of administration and oversight. According to the disclosure, the System Administrator 50 negotiates agreements to define the rights and responsibilities of the participating entities. Participating entities include, but are not limited to: the System Administrator 50, Participating Organizations 90, a Host Financial Institution 30, a network of Preferred Providers 80 and network operators such as ACH 40.

FIG. 1 illustrates the relationships and funds flow between the participating entities according to aspects of the disclosed systems and methods. FIG. 1 is a simplified diagram showing only one of each participating entity. It will be understood that the disclosed systems and methods will typically involve many Affiliated Individuals 10, Participating Organizations 90 and Preferred Providers 80. The disclosed systems and methods are not limited to the use of a single Host Financial Institution 30 or System Administrator 50. At the center of the diagram is the System Administrator 50. The System Administrator 50 negotiates agreements with each Participating Organization 90, the Host Financial Institution 30 and each Preferred Provider 80 of goods and/or services. The System Administrator 50 also manages the funds accumulation system, communicates with the participating entities and distributes the resulting funds according to the agreements. These functions of the System Administrator 50 are typically facilitated by one or more computer systems 54.

The agreement between the System Administrator 50 and the Participating Organization 90 memorializes the rights and responsibilities of the parties. The System Administrator 50/Participating Organization 90 agreement may include compensating the System Administrator 50 with a portion of the funds accumulated according to the disclosed method. The System Administrator 50/Participating Organization 90 agreement may also set forth the form in which funds are distributed to the Participating Organization 90, for example as a royalty for use of the name and trademarks of the Participating Organization 90. The form of the Participating Organization 90 is not limited and may include schools, health care institutions such as hospitals, non-profits, charities, and commercial enterprises. The disclosed systems and methods are compatible with large or small Participating Organizations 90. In one embodiment, the Participating Organization may be a real estate agency or individual realtor, a contractor or an individual operating as a subcontractor. The disclosed systems and methods provide a mechanism for pooling the purchasing power of numerous small Participating Organizations 90 and leveraging the purchasing power of those Affiliated Individuals 10 interested in participating.

The agreement between the System Administrator 50 and the Host Financial Institution 30 sets forth the services to be provided by the Host Financial Institution 30, including but not limited to: establishment of one or more System Administrator Account(s) 32 through which funds will flow according to the disclosed method, issuance of appropriate spending vehicles 20 such as debit cards, and the maintenance of individual debit accounts 34. The agreement between the System Administrator 50 and the Host Financial Institution 30 may also include the manner in which the Host Financial Institution 30 will be compensated for its services. For example, the Host Financial Institution 30 may be compensated from earnings (Float $ 47) generated by funds held in the System Administrator Account(s) 32.

The agreement 70 between the System Administrator 50 and each Preferred Provider 80 relates to the discount 48 the Preferred Provider 80 agrees to grant on purchases made using spending vehicles 20 according to the disclosed method. In exchange for the agreed upon discount 48, the Preferred Provider may be listed on the spending vehicle 20, e.g., have their name and/or logo printed on a debit card. The Preferred Provider 80 may be listed on a web portal provided by the System Administrator 50 and promoted to the Participating Organization 90 and/or any Affiliated Individual 10 participating in the disclosed method. The agreement 70 between the System Administrator 50 and each Preferred Provider 80 may set forth the manner in which discount funds 48 are returned to the System Administrator 50. For example, the agreement may permit the System Administrator 50 to periodically draw on an agreed upon account 200 to retrieve accumulated discount funds 48 across an electronic funds transfer network 40 such as the ACH (Automated Clearing House) or EDI (Electronic Data Interchange).

In an enhancement to the disclosed systems and methods, valuable consumer information 100 about Affiliated Individuals 10, such as email addresses, mailing addresses, purchasing patterns and the like may be collected by the System Administrator 50. In accordance with the Participating Organization/System Administrator agreement 70 and subject to voluntary participation by Affiliated Individuals 10, portions of the consumer information 100 may be offered to Preferred Providers 80 to enhance their access to and information about the Affiliated Individuals 10. Preferred Providers 80 may be permitted to market directly to those Affiliated Individuals 10 who express an interest in receiving such solicitations.

From the perspective of a Preferred Provider 80, the negotiated discounts 48 are essentially the only cost of participating in the disclosed method because all transactions are carried out via electronic networks 40 already in place. The discounts 48 likely represent a smaller percentage of sales than the cost of advertising or other promotional efforts. Further, in contrast to advertising and promotional programs, the discount 48 is paid only when a qualified purchase is actually made. The loyalty of the Affiliated Individuals 10 to Preferred Providers 80 is likely to be high given the knowledge that revenue generated by their purchases will support an organization in which they have an interest, or from which they benefit.

With agreements in place between the System Administrator 50, Participating Organization 90, Host Financial Institution 30 and Preferred Providers 80, an embodiment of the disclosed method functions according to the relationships illustrated in FIG. 1. The Participating Organization 90 promotes the disclosed funds accumulation method to Affiliated Individuals 10. Affiliated individuals 10 may be restricted to employees or may be open to anyone interested in participating, depending upon the form of the Participating Organization 90 and its goals. For example, tax regulations may restrict some charitable organizations or non-profit entities from engaging in “commercial activity.” In the case of such charitable organizations, it may be necessary to restrict the pool of Affiliated Individuals 10 to employees and their families to reduce the likelihood that the funds accumulation method will be deemed commercial activity. These restrictions do not apply to schools and religious institutions such as churches.

According to one embodiment, an Affiliated Individual 10 applies for a debit account 34 through a web portal 60 provided by the Host Financial Institution 30, who processes the application, establishes the debit account 34 and issues the spending vehicle 20. Alternatively, the System Administrator 50, or the Participating Organization 90 may collect the necessary information and forward it to the Host Financial Institution 30 for processing. Since the debit accounts 34 are prepaid, there is no need for a credit check and no need for the Affiliated Individual 10 to have good credit. Once a debit account 34 has been established, an Affiliated Individual 10 funds the account by electronic funds transfer (EFT) through a web portal or by payroll deduction. Other means for funding the debit account are also possible, such as deposits or transfers initiated at an Automated Teller Machine (ATM) networked with the Host Financial Institution 30. The debit accounts 34 will be insured by the FDIC, so Affiliated Individuals 10 are insured against failure of the Host Financial Institution 30. According to one embodiment, the System Administrator Account 32 at the Host Financial Institution 30 may take the form of a master account, with ledgers for each debit account 34. The master account may be dedicated to a single large Participating Organization 90, or may be used to contain accounts for many smaller Participating Organizations 90.

The Host Financial Institution 30 issues a spending vehicle 20 that allows the Affiliated Individual 10 to access funds in the debit account 34. The term “spending vehicle” as used in this application is intended to encompass any card or device that allows the Affiliated Individual 10 to access or spend funds in the debit account 34. Spending vehicles 20 include, but are not limited to: debit cards, RFID “swipe and go” devices, and electronic devices such as cell phones or personal digital assistants (PDAs) configured to interact with point of sale terminals or e-commerce networks. The most likely spending vehicle 20 is a debit card of the type commonly accepted at point of sale terminals and ATMs. The debit card may be used to access funds in the debit account 34 wherever debit cards are accepted, including but not limited to point of sale terminals associated with Preferred Providers 80. The disclosed spending vehicle 20 and linked debit account 34 allow the Affiliated Individual 10 maximum flexibility in accessing funds in the debit account 34. In contrast, many stored value cards are restricted to the purchase of goods or services from a single provider and cannot be used in an ATM.

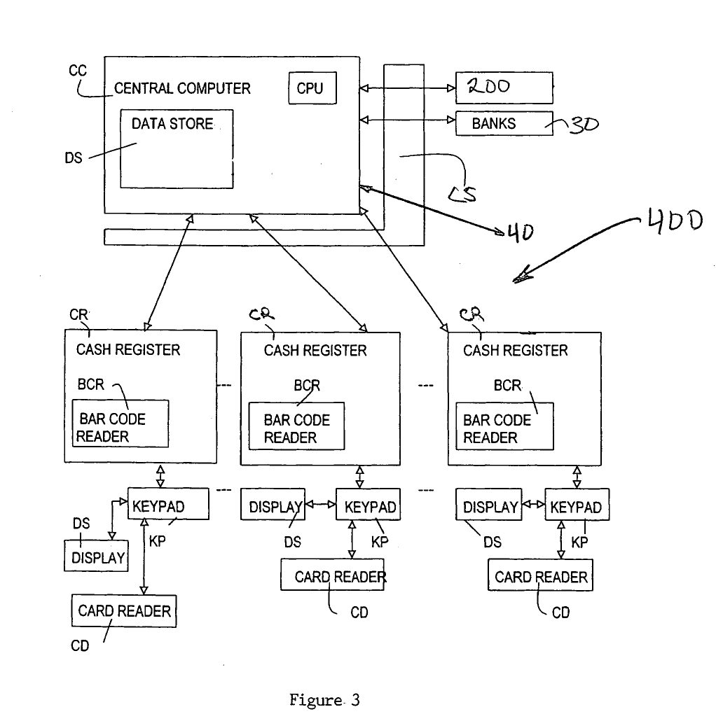

The consumer transactions and funds transfers illustrated in FIG. 1 are conducted on networks and equipment that are already in place and do not require any material changes to existing practices, systems or equipment. Discount funds 48 are generated when an Affiliated Individual 10 uses a spending vehicle 20 to purchase goods or services from a Preferred Provider. When a spending vehicle 20 is used to initiate a purchase at a Preferred Provider 80, a point of sale terminal (such as a cash register CR1 in FIG. 3) at the Preferred Provider 80 sends a request through a network 40 to the Host Financial Institution 30 to verify that sufficient funds are available in the debit account 34. If sufficient funds are not available, the transaction is declined and the purchase must be made by other means. If sufficient funds are available, the transaction is approved and completed at the point of sale, generating a funds transfer request from the Preferred Provider 80 to the Host Financial Institution 30. The Host Financial Institution 30 debits the account 34 an amount equal to the total purchase of goods or services at the Preferred Provider 80 and forwards those funds by electronic transfer to the Preferred Provider 80. The funds query, approval and funds transfer are conducted on existing electronic networks 40 used to complete consumer transactions, the operation of which will be familiar to those of skill in the art.

The disclosed funds accumulation systems and methods are designed to take advantage of well-established point of sale (POS) terminals and electronic networks 40, making them extremely efficient and reducing costs to all participants. In many cases, a particular purchase and the associated discount will be quite small. By efficiently accumulating the discount funds generated from numerous small purchases using established electronic networks, the proposed funds accumulation systems and methods can generate significant funds for the Participating Organization 90.

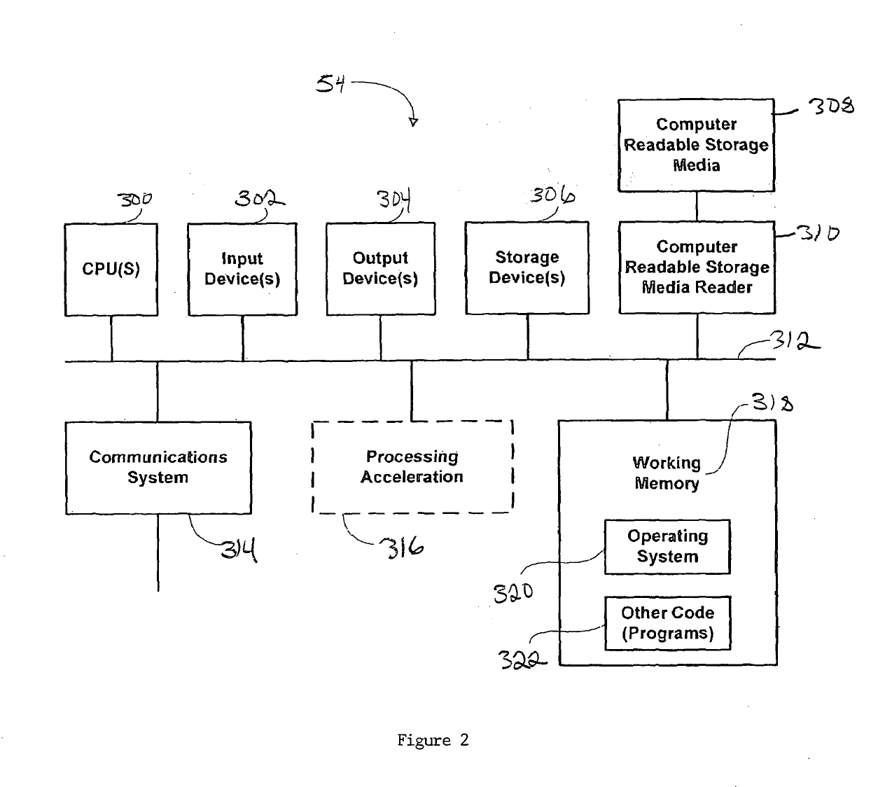

FIG. 2 illustrates an exemplary computer system 54 that may be programmed to implement the disclosed methods and form part of the disclosed systems. FIG. 2 provides a schematic illustration of a structure that may be used to implement the computer system 54. The computer system 54 is shown comprised of hardware elements that are electrically coupled via bus 312, including a processor (CPU) 300, an input device 302, an output device 304, a storage device 306, a computer-readable storage media reader 310, a communications system 314, a processing acceleration unit 316 such as a DSP or special-purpose processor, and a memory 318. The computer-readable storage media reader 310 is further connected to a computer-readable storage medium 308, the combination comprehensively representing remote, local, fixed, and/or removable storage devices plus storage media for temporarily and/or more permanently containing computer-readable information. The communications system 314 may comprise a wired, wireless, modem, and/or other type of interfacing connection and permits data to be exchanged with electronic networks 40, Host Financial Institution 30, Preferred Providers 80 and other networks such as the Internet (not shown) to implement embodiments as described herein.

The computer system 54 also comprises software elements, shown as being currently located within working memory 318, including an operating system 320 and other code 322, such as a program designed to implement the disclosed methods. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

The disclosed methods may be embodied in a computer-readable storage media 308 having a computer-readable program 322 stored therein for directing operation of the computer system 54. The computer-readable program 322 includes instructions for operating the computer system 54 to process financial transactions according to the disclosed embodiments. Those skilled in the art will understand that the disclosed systems may be embodied in several computers linked by a network and connected to peripheral devices for conducting consumer transactions, accessing funds located in accounts, and storing information regarding consumer transactions, account activity and balances.

FIG. 3 illustrates an exemplary Preferred Provider retail system 400 including a central computer CC containing a central processor CPU and data storage DS. A communications system CS that may include telephone lines, satellites, or cables connects the central computer CC to a number of cash registers CR, which may also be referred to as point of sale (POS) terminals. The cash registers CR may be located in the same facility as the central computer CC or may be located in retail outlets, such as shops, supermarkets, gasoline stations, department stores, etc. at locations remote from the central computer. The cash registers CR typically include respective keypads KP and card readers CD. Each cash register CR, keypad KP, and card reader CD connected to each other represents an exemplary POS terminal. Each cash register CR is connected to the central computer CC. The data storage DS contains individual storages for charity accounts CA and other accounts OA, such as for banks etc., all with ledgers for individual consumers. The communications system CS also connects the central computer CC to other computers such as bank computers BK including the Host Financial Institution 30 and one or more Preferred Provider accounts 200, electronic networks 40, etc. The cash register CR includes a display DS for exhibiting transactions. A card reader CD with a keypad KP allows the Affiliated Individual 10 or clerk to swipe a debit card spending vehicle 20 and enter relevant information such as a Personal Identification Number (PIN), if required. The cash register CR (or other POS terminal) communicates with the central computer CC via the communication system CS. The central computer CC maintains records of transactions in its Data Storage DS and may produce periodic reports.

The exemplary retail system 400 includes a conventional card reader CD, but the disclosed systems and methods are not limited to such devices. A spending vehicle 20 compatible with the disclosed systems and methods may be configured to interact with any device that permits communication with the retail system of any seller of goods or services. Such devices include, but are not limited to RFID readers and terminals configured to communicate wirelessly with cell phones, PDAs or other portable electronic devices configured to conduct consumer or commercial transactions. The disclosed systems and methods are compatible with any consumer or commercial transaction carried out on existing or contemplated commercial networks.

When an Affiliated Individual 10 uses their debit card at a non-preferred provider, the debit card acts in the ordinary way and no discount funds are generated. An aspect of the disclosure relates to a spending vehicle 20 that allows the Affiliated Individual 10 to spend debit account funds anywhere, or access those funds through ATMs. Knowing that funds are available for any purpose, Affiliated Individuals 10 are more likely to participate in the disclosed funds accumulation systems and methods, and are more likely to deposit funds in the debit account 34. An objective of the disclosed funds accumulation systems and methods is to make participation convenient, inexpensive and flexible.

The discount funds 48 generated at Preferred Providers 80 from sales to Affiliated Individuals 10 will be returned to the System Administrator 50 according to the terms of the System Administrator/Preferred Provider agreement 70. According to one embodiment, such an agreement 70 may authorize the System Administrator 50 to periodically draw accumulated discount funds 48 from an account 200 maintained by the Preferred Provider 80. According to a typical procedure, the System Administrator 50 provides a report identifying the qualifying transactions and the associated discounts for each draw. The Preferred Provider 80 is typically afforded a period of time to audit the report and contest amounts improperly withdrawn. In an alternative configuration, the discount funds 48 generated by qualifying transactions are transferred to the System Administrator 50 in real time. Other arrangements for transfer of discount funds 48 from Preferred Providers 80 to the System Administrator 50 will occur to those skilled in the art and are intended to be encompassed by the appended claims.

The System Administrator 50 accumulates discount funds 48 from Preferred Providers 80 and forwards them to the Participating Organization 90 according to the terms of the System Administrator/Participating Organization agreement. Participating Organizations 90 may be schools, charitable organizations, non-profits, commercial businesses or any organization wishing to leverage the combined buying power of its employees, members and/or beneficiaries. The Participating Organization 90 may use the funds for general or specific purposes. One example of a use for the funds would be to provide or subsidize healthcare coverage for employees. Another example is to provide retirement fund contributions for employees. In most cases, the Participating Organization 90 would use the funds to contract with a health insurance company or retirement fund administrator to provide the employee benefit.

The System Administrator 50 may be compensated from any one or a combination of several sources. First, the System Administrator 50 may charge a fee 46 when each Affiliated Individual 10 applies for a debit account 34. Second, the System Administrator 50 may retain an agreed upon portion of the discount funds 48 accumulated on behalf of a Participating Organization 90. Finally, the combined funds of Affiliated Individuals 10 residing in the System Administrator 50 Account with the Host Financial Institution 30 may provide significant interest income (Float $ 47), some portion of which may be used to compensate the System Administrator 50. Compensation of the System Administrator 50 may differ according to the terms of agreements negotiated among the participating entities.

Preferred Providers 80 of goods and services are not limited and preferably include grocery stores, department stores, home improvement stores, gas stations, etc. A Preferred Provider 80 may be any type of retail or service establishment willing to enter into a Preferred Provider agreement 70 with the System Administrator 50. The System Administrator 50 offers the Preferred Provider 80 special access to the combined purchasing power of the Affiliated Individuals 10 in exchange for a discount on purchases made by those Affiliated Individuals. The agreed upon discount 48 may vary depending upon the product or service, with low margin products or services naturally granting a smaller discount. High margin categories such as gift cards may allow for a higher discount. Preferred Providers 80 gain access to a group of grateful customers who are motivated to direct their purchases to a Preferred Provider 80. In many cases the funds 49 generated for the Participating Organization 90 will directly benefit the Affiliated Individual 10 in the form of higher salaries, employee benefits, or services provided by the Participating Organization 90.

By making a broad range of goods and services available to the Affiliated Individual 10 through a network of Preferred Providers 80, the funds accumulation method seeks to maximize purchases that will generate discount funds for the Participating Organizations 90. Preferred Providers 80 will be selected based on criteria that may include: the breadth and quality of their product offerings, the number and convenience of their retail outlets, and the discount they are willing to provide. Appropriate goods and services preferably include those that Affiliated Individuals 10 consumed on a regular basis such as fuel, food, clothing, car repairs and the like. Since these are necessary recurring purchases, participation in the disclosed method is not a burden on the Affiliated Individual 10; they are just spending money that would be spent in the absence of the disclosed method. An objective of the disclosed funds accumulation method is to create a network of Preferred Providers that will be convenient for Affiliated Individuals 10 to use and that will have the best potential to generate funds for the Participating Organization 90. A network of Preferred Providers 80 meeting these criteria will in turn attract Participating Organizations 90 and Affiliated Individuals 10. Preferential access to the purchasing power of a large number of motivated Affiliated Individuals 10 is obviously very attractive to prospective Preferred Providers 80.

Having shown and described several embodiments of the disclosed funds accumulation systems and methods, those skilled in the art will recognize that many variations and modifications may be made to the described embodiments. Accordingly, the above description should not be taken as limiting the scope of the invention, which is defined in the following claims.

1. A funds accumulation method comprising:
establishing a system administrator for managing a funds accumulation system, said system administrator having a system administrator account with a host financial institution, said host financial institution connected to electronic networks used to conduct consumer transactions and transfer funds;
opening a debit account at said host financial institution for each of a plurality of affiliated individuals associated with a participating organization, each said debit account associated with a spending vehicle and provided with funds by each said affiliated individual, said spending vehicle providing access to said funds for completing consumer transactions;
establishing a network of preferred providers of goods and services who provide said goods and services to said plurality of affiliated individuals in exchange for funds from said debit accounts, said preferred providers agreeing to a pre-determined discount for purchases made with said spending vehicles, said discount being retained by said preferred provider and not used to reduce an amount deducted from said debit account to complete said purchases;
recording purchases made with said spending vehicles and calculating a sum of all discounts generated by said purchases at each preferred provider during a pre-determined period;
transferring an accumulated funds amount equal to said sum of all discounts for said pre-determined period from said preferred provider to said system administrator, said system administrator delivering a pre-determined portion of said accumulated funds to said participating organization.

2. The funds accumulation method of claim 1, wherein said step of transferring comprises said system administrator accessing an account maintained by said preferred provider to withdraw said accumulated funds.

3. The funds accumulation method of claim 1, wherein said participating organization is an educational institution, a religious organization, a charity or a non profit entity.

4. The funds accumulation method of claim 1, wherein said affiliated individual provides funds to said debit account by payroll deduction or electronic funds transfer.

5. A system for accumulating funds from consumer transactions comprising:
a network for facilitating consumer transactions and the transfer of funds, said network interfaced with a plurality of transaction devices;
a plurality of prepaid spending vehicles usable at said plurality of transaction devices to conduct consumer transactions;
a host financial institution issuing said prepaid spending vehicles and maintaining a debit account associated with each said prepaid spending vehicle where prepaid funds are stored, said host financial institution connected to said network;
a plurality of preferred providers of goods or services, each of said plurality of preferred providers having at least one of said transaction devices connected to said network for carrying out said consumer transactions where said prepaid funds are transmitted across said network in exchange for goods or services and at least one account accessible from said network, said preferred provider associating a discount with each consumer transaction conducted with said prepaid spending vehicles, said discount being retained by said preferred provider and not used to reduce an amount deducted from said debit account to complete said purchases; and
a third party having an agreement with each of said preferred providers that the discounts retained by said preferred providers will be periodically transferred to said third party,
whereby funds equal to a sum of said discounts are accumulated with said third party.

6. The system of claim 5, comprising:
a participating organization including a plurality of affiliated individuals, at least some of said affiliated individuals using said prepaid spending vehicles to conduct said consumer transactions and generate said discounts, said member organization receiving from said third party at least a portion of the accumulated discounts generated by said affiliated individuals.

7. The system of claim 5, wherein said third party enters into agreements with said host financial institution governing issuance of said prepaid spending vehicles, and with said preferred providers setting the rate of said discount.

8. The system of claim 5, wherein said preferred provider agrees that said third party is permitted to extract an amount equal to the sum of said discounts from said at least one account across said network.

9. The system of claim 5, wherein said retained discounts are transferred to said third party in real time.

10. The system of claim 5, wherein said retained discounts are transferred to said third party according to an agreed upon schedule.
